(19) United States
(12) Patent Application Publication
(10) Pub. No.: US 2013/0207916 A1
(43) Pub. Date: Aug. 15, 2013

(54) MULTIMEDIA DEVICE FOR CONTROLLING LOGO TYPE INDICATOR ACCORDING TO POWER CONTROL SIGNAL AND METHOD OF CONTROLLING THE SAME

(71) Applicant: LG Electronics Inc., (US)

(72) Inventors: Bonjoon KOO, Seoul (KR); Sooman LEE, Seoul (KR); Sunyoung YU, Seoul (KR)

(73) Assignee: LG ELECTRONICS INC., Seoul (KR)

(21) Appl. No.: 13/766,596

(22) Filed: Feb. 13, 2013

(30) Foreign Application Priority Data
Feb. 14, 2012 (KR) 10-2012-0015043

(51) Int. Cl. G06F 3/038

(52) U.S. Cl. CPC G06F 3/038
USPC 345/173; 345/212

(57) ABSTRACT

A multimedia device for controlling a logo type indicator according to a power control signal is disclosed. The multimedia device includes a power supply unit for supplying power, a light source unit for emitting light in a specific direction according to power supplied by the power supply unit, a logo type assembly designed to transmit light emitted from the light source unit, and a controller for controlling a power supply state of the power supply unit in at least two states according to a power control signal or mode of the multimedia device.

This application claims the benefit of Korean Patent Application No. 10-2012-0015043, filed on Feb. 14, 2012, which is hereby incorporated by reference as if fully set forth herein.

### BACKGROUND OF THE INVENTION

1. Field of the Invention

The present invention relates to a multimedia device, and more particularly, to a multimedia device for controlling a logo type indicator according to a power control signal and a method of controlling the same. The multimedia device may be applied to, for example, a digital television (DTV), a network TV, an Internal protocol television (IPTV), a smart TV, a web TV, a mobile device, a smart phone, or the like.

2. Discussion of the Related Art

In a multimedia device according to conventional technologies, for example, a television (TV) receiver, a power related lamp is attached to a lower right end portion of a bezel surrounding a screen and a logo indicating a maker is separately printed on a central lower end portion. In general, the power related lamp, for example, a light emitting diode (LED) is simply blinks to indicate power on/off.

According to the present state of technological development, the results of research and development for competitively reducing the thickness of a bezel have been achieved. For example, currently, a TV receiver having a bezel thickness of 1 mm to 5 mm has been introduced.

However, according to such conventional technologies, due to the reduced bezel thickness, a logo indicating a maker of a TV receiver cannot be printed or cannot be easily recognized by users.

Furthermore, a power lamp, for example, an LED needs to be separately designed, thereby increasing design cost in terms of hardware. In addition, there has been a need for a solution to provide an indicator that is changed according to a power state, mode change, and the like of a multimedia device for providing various functions.

### SUMMARY OF THE INVENTION

Accordingly, the present invention is directed to a multimedia device for controlling a logo type indicator according to a power control signal and a method of controlling the same that substantially obviate one or more problems due to limitations and disadvantages of the related art.

An object of the present invention is to provide an indicator for providing various functions by combining a conventional power lamp and a printed logo.

Another object of the present invention is to provide an interface through which a user can directly set an execution mode of a logo type indicator, or a solution for automatically changing an execution mode of the logo type indicator according to a state of the multimedia device.

Another object of the present invention is to provide a technology for performing different functions of a multimedia device based on information of a location, a time, and the like that a logo type indicator is touched.

Another object of the present invention is to provide a technology for automatically changing brightness, color, and the like of a logo type indicator based on information of a current time, surrounding brightness, and the like.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a multimedia device for controlling a logo type indicator according to a power control signal includes a power supply unit for supplying power, a light source unit for emitting light in a specific direction according to power supplied by the power supply unit, a logo type assembly designed to transmit light emitted from the light source unit, the logo type assembly being positioned at one side surface of a screen with video data output from the multimedia device being displayed thereon, and a controller for controlling a power supply state of the power supply unit in at least two states according to a power control signal or mode of the multimedia device.

In another aspect of the present invention, a method of controlling a logo type indicator according to a power control signal includes setting a first state of a target logo type indicator in a power on state of the multimedia device, setting a second state of the target logo type indicator in a standby state of the multimedia device, controlling the logo type indicator in the first state when a power on signal for control of the multimedia device is received, and controlling the logo type indicator in the second state when a standby command for control of the multimedia device is received.

In another aspect of the present invention, a multimedia device for controlling a logo type indicator positioned independently from a screen of the multimedia device includes a recognition module for identifying a corresponding user when the logo type indicator is touched, a power supply module for switching the multimedia device from a first power state to a second power state, a memory for storing at least one user identification information and corresponding additional information, a controller accessing the memory to extract the additional information corresponding to the identified user, and a video data processor controlled to preferentially output video data on the screen of the multimedia device according to the extracted additional information.

In another aspect of the present invention, a method of controlling multimedia device for controlling a logo type indicator includes displaying a first option for setting a display level of a logo type indicator according to a power state of the multimedia device, the logo type indicator being positioned independently from a screen of the multimedia device, displaying a second option for setting a display level of the logo type indicator according to a mode of the multimedia device, the first option and the second option being displayed at the same time or different times, changing display of the logo type indicator according to the set first option and power state of the multimedia device, and changing the display of the logo type indicator according to the set second option and mode of the multimedia device.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram of an external appearance of a logo type indicator of a multimedia device according to an embodiment of the present invention;

FIG. 2 is a diagram of an external appearance of logo type indicators of a multimedia device according to another embodiment of the present invention;

FIG. 3 is a detailed block diagram of internal modules of a multimedia device according to an embodiment of the present invention;

FIG. 4 is a diagram of a structure of a logo type assembly according to an embodiment of the present invention;

FIG. 5 is a graph showing experimental data about a power supply state of a multimedia device that receives a power on signal, according to an embodiment of the present invention;

FIG. 6 is a graph showing experimental data about a power supply state of a multimedia device that receives a power on signal, according to another embodiment of the present invention;

FIG. 7 is a graph showing experimental data about a power supply state of a multimedia device that receives a power off signal, according to another embodiment of the present invention;

FIG. 8 is a graph showing experimental data about a power supply state of a multimedia device that receives a power off signal, according to another embodiment of the present invention;

FIG. 9 is a diagram of a GUI for setting a state of a logo type indicator, according to an embodiment of the present invention;

FIG. 10 is a diagram showing a first process in which a state of a logo type indicator is changed, according to an embodiment of the present invention;

FIG. 11 is a diagram showing a second process in which a state of a logo type indicator is changed, according to an embodiment of the present invention;

FIG. 12 is a diagram showing a third process in which a state of a logo type indicator is changed, according to an embodiment of the present invention;

FIG. 13 is a diagram showing a fourth process in which a state of a logo type indicator is changed, according to an embodiment of the present invention;

FIG. 14 is a diagram of a fifth process in which a state of a logo type indicator is changed, according to an embodiment of the present invention;

FIG. 15 is a diagram of a sixth process in which a state of a logo type indicator is changed, according to an embodiment of the present invention;

FIG. 16 is a diagram of a seventh process in which a state of a logo type indicator is changed, according to an embodiment of the present invention

FIG. 17 is a diagram showing a database (DB) for adjusting brightness/color of a logo type indicator based on a current time, according to an embodiment of the present invention;

FIG. 18 is a flowchart of a method of controlling a multimedia device according to an embodiment of the present invention;

FIG. 19 is a detailed block diagram of internal modules of a multimedia device according to another embodiment of the present invention;

FIG. 20 is a diagram of a DB stored in a memory of a multimedia device, according to another embodiment of the present invention;

FIG. 21 is a diagram showing a process in which a multimedia device is switched to a power on state according to a touch of a first user, according to another embodiment of the present invention;

FIG. 22 is a diagram showing a process in which a multimedia device is switched to a power on state according to a touch of a second user, according to another embodiment of the present invention;

FIG. 23 is a diagram showing a process in which a multimedia device changes a state of a logo type indicator when a specific event occurs, according to an embodiment of the present invention;

FIG. 24 is a diagram related to an internal process for supplementary description of FIG. 23;

FIG. 25 is a diagram of a structure of a logo type assembly according to another embodiment of the present invention;

FIG. 26 is a diagram of an example of a GUI provided by a multimedia device according to another embodiment of the present invention;

FIG. 27 is a diagram of an example of a GUI provided by a multimedia device according to another embodiment of the present invention; and

FIG. 28 is a flowchart of a method of controlling a multimedia device according to another embodiment of the present invention.

### DETAILED DESCRIPTION OF THE INVENTION

Reference will now be made in detail to the preferred embodiments of the present invention, examples of which are illustrated in the accompanying drawings.

The suffixes “module” and “unit” of elements herein are convenience of description and thus can be used interchangeably.

Hereinafter, the present invention will be described in detail by explaining exemplary embodiments of the invention with reference to the attached drawings, but should not be limited by the exemplary embodiments.

Most of the terms used herein are selected in consideration of functions and are general terms that have been widely used in the technical art to which the present invention pertains. However, some of the terms used herein may be created reflecting intentions of technicians in this art, practices, or new technologies. Also, some of the terms used herein may be arbitrarily chosen by the present applicant. In this case, these terms are defined in detail below. Accordingly, the specific terms used herein should be understood based on the unique meanings thereof and the whole context of the present invention

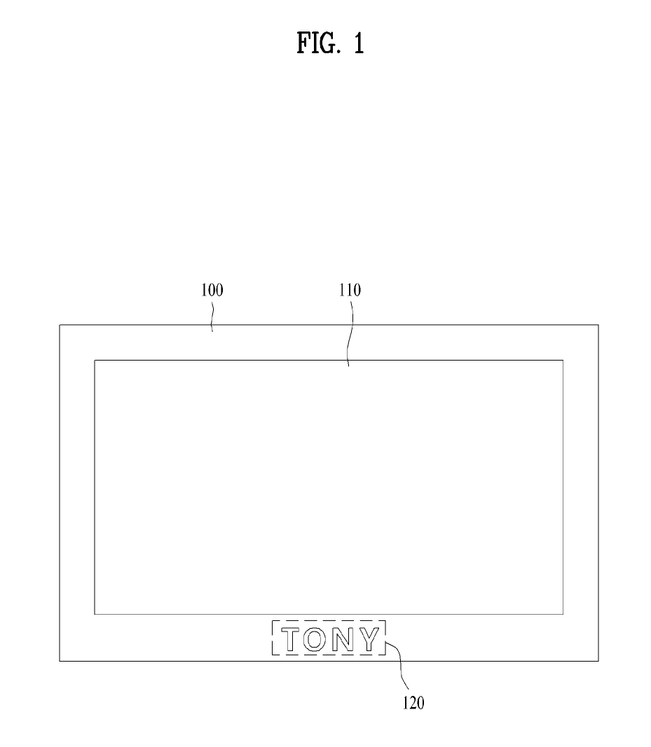

FIG. 1 is a diagram of an external appearance of a logo type indicator 120 of a multimedia device 100 according to an embodiment of the present invention. Hereinafter, a case in which the multimedia device 100 according to the present embodiment includes one logo type indicator will be described with reference to FIG. 1.

As shown in FIG. 1, the multimedia device 100 includes a screen 110 on which video data is output. In addition, the multimedia device 100 further includes the logo type indicator 120 that is dynamically changed according to a power control signal or an operation mode of the multimedia device 100.

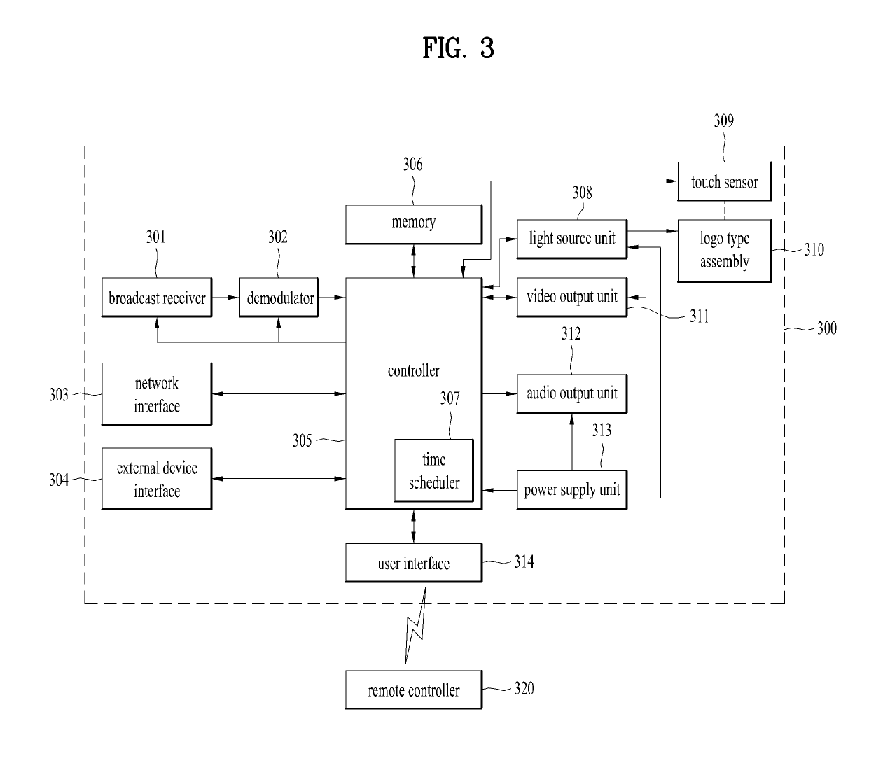

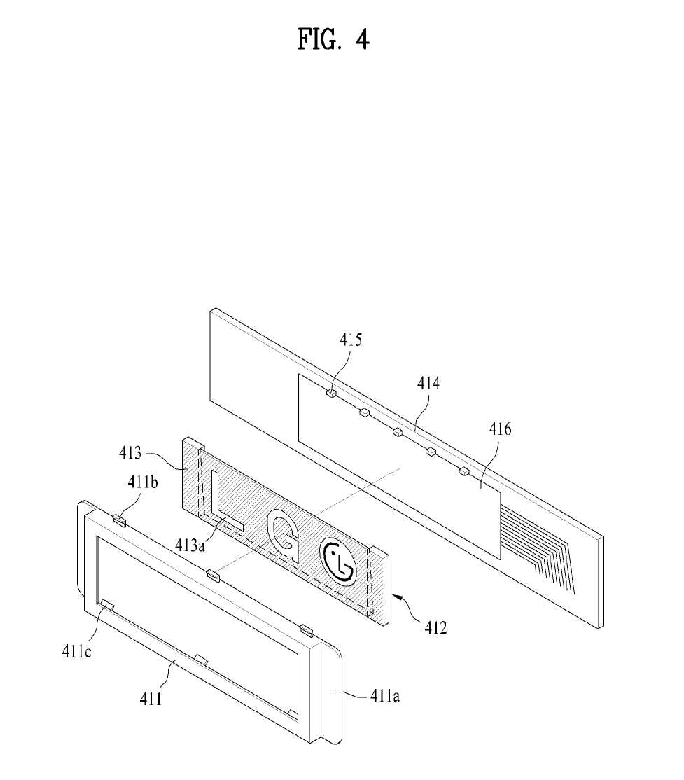

A solution for processing an electrical signal by the logo type indicator 120 will be described in detail with reference to FIG. 3. An assembly structure for mechanically implementing the solution will be described in detail with reference to FIG. 4.

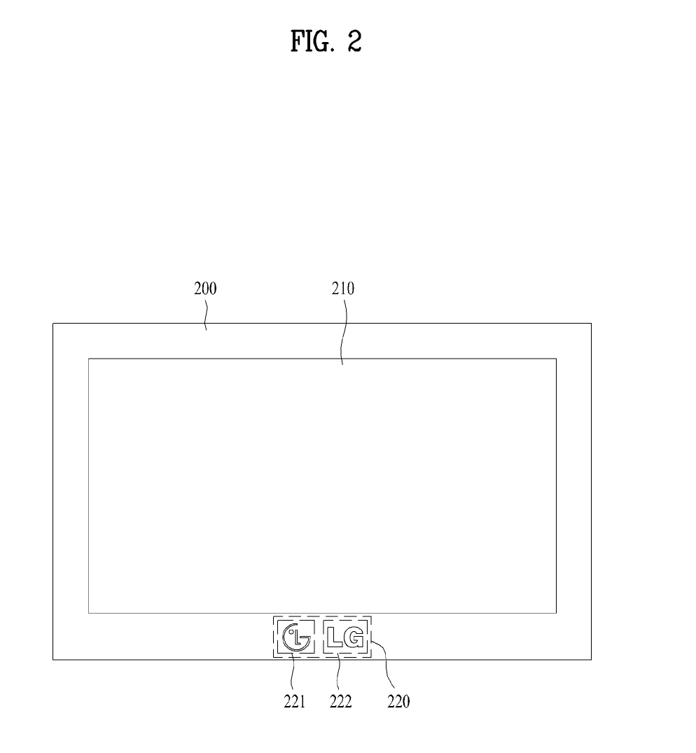

FIG. 2 is a diagram of an external appearance of logo type indicators 221 and 222 of a multimedia device 200 according to another embodiment of the present invention. Hereinafter, a case in which the multimedia device 200 according to the present embodiment includes the plurality of logo type indicators 221 and 222 will be described with reference to FIG. 2.

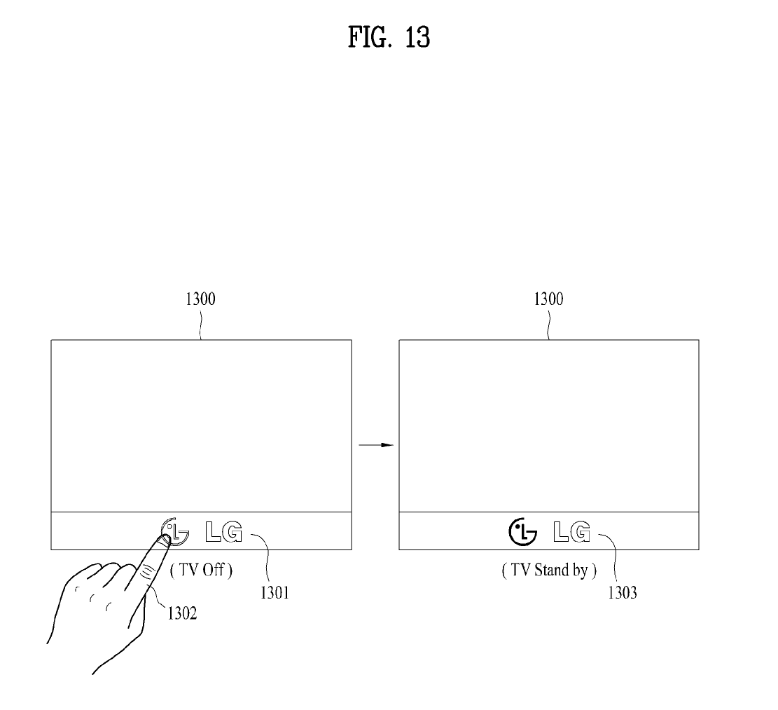

Compared with the case shown in FIG. 1, the multimedia device 200 of FIG. 2 also includes one screen 210. However, unlike in FIG. 1, the multimedia device 200 is advantageous for providing various options to users by additionally designing the plurality of logo type indicators 221 and 222. Of course, an embodiment in which the plurality of logo type indicators 221 and 222 is designed to constitute one module 220 is within the scope of the present invention. A technological effect of a case in which the aforementioned plurality of logo type indicators is separately designed will be described in more detail with reference to FIGS. 13 to 16.

The designed logo type indicators 120 and 220 shown in FIGS. 1 and 2 are advantageous for providing as much information as possible to users as well as, for replacing both a conventional power lamp and a logo image that is simply printed on a bezel, which will be described below.

FIG. 3 is a detailed block diagram of internal modules of a multimedia device 300 according to an embodiment of the present invention. Hereinafter, a process in which the multimedia device 300 selectively/stepwise controls power supply to a logo type indicator will be described with reference to FIG. 3.

As shown in FIG. 3, the multimedia device 300 according to the present embodiment includes a broadcast receiver 301, a demodulator 302, a network interface 303, an external device interface 304, a controller 305, a video output unit 311, an audio output unit 312, a power supply unit 313, a user interface 314, a memory 306, a light source unit 308, a touch sensor 309, and a logo type assembly 310. The controller 305 further includes a time scheduler 307, and the multimedia device 300 is controlled by a remote controller 320 or the touch sensor 309. Of course, FIG. 3 illustrates a pure example for describing an embodiment of the present invention, and thus, the scope of the invention is defined by the appended claims.

The broadcast receiver 301 may be designed as, for example, a radio frequency (RF) tuner or an interface for receiving broadcast data from an external device such as a set top box (STB). The broadcast receiver 301 may receive, for example, RF broadcast signals of a single carrier using an advanced television system committee (ATSC) method or RF broadcast signals of a plurality of carriers using a digital video broadcasting (DVB) method.

The demodulator 302 receives a digital intermediate frequency (DIF) signal converted by the broadcast receiver 301 and performs a demodulation operation. For example, when the DIF signal output from the broadcast receiver 301 is based on the ATSC method, the demodulator 302 performs, for example, 8-vestigal side band (8-VSB) demodulation.

The external device interface 304 is an interface facilitating data communication between an external device and the multimedia device 300. The external device interface 304 may be connected to an external device such as a digital versatile disc (DVD), a Blu-ray player, a game console, a camera, a camcorder, a computer (notebook computer), or an STB by wire or wirelessly.

The external device interface 304 may include, for example, a universal serial bus (USB) terminal, a composite video banking sync (CVBS) terminal, a component terminal, an S-video terminal (analog), a digital visual interface (DVI) terminal, a high definition multimedia interface (HDMI) terminal, an RGB terminal, a D-subminiature (D-SUB) terminal, or the like.

The network interface 303 provides an interface for connecting the multimedia device 300 to a wired/wireless network including the Internet. The network interface 303 may include, for example, an Ethernet terminal or the like for connection with a wired network and may use a communication standard, for example, wireless LAN (WLAN), wireless fidelity (Wi-Fi), wireless broadband (WiBro), world interoperability for microwave access (WiMax), or high speed downlink packet access (HSDPA) for connection with a wired network.

The user interface 314 transmits a signal input by a user to the controller 305 or a signal from the controller 305 to an external device (e.g., the remote controller 320). For example, the user interface 314 is designed to receive and process a control signal such as a power on/off signal, a channel selection signal, screen setting signal, or the like from the remote controller 320 or to transmit a control signal from the controller 305 to the remote controller 320 according to various communication methods such as RF communication, infrared (IR) communication, or the like.

The video output unit 311 converts an image signal, a data signal, or an on screen display (OSD) signal, which is processed by the controller 305, or an image signal or a data signal which is received from the external device interface 304 into red (R), green (G), and blue (B) signals to generate a drive signal. The audio output unit 312 receives a signal that is audio-processed by the controller 305, for example, a stereo signal, a 3.1 channel signal, or a 5.1 channel signal to output sound.

In addition, the power supply unit 313 supplies corresponding power to the multimedia device 300. In particular, an embodiment of the present invention has the feature of selectively/stepwise controlling power supplied to the light source unit 308 in order to adjust the color and brightness of a logo type indicator.

That is, the power supply unit 313 is designed to supply power and the light source unit 308 is designed to emit light in a specific direction according to power supplied by the power supply unit 313. For example, the light source unit 308 may be implemented using an LED backlight unit (BLU) or the like.

The logo type assembly 310 is designed to transmit light emitted from the light source unit 308, and for example, may be designed to have a logo design shape indicating a manufacturer of the multimedia device 300. In addition, the logo type assembly 310 is positioned at, for example, one side surface of a screen on which video data output from the multimedia device 300 is displayed. As in FIG. 1 or 2, the logo type assembly 310 may be designed to be positioned at a lower end portion of the screen.

In addition, the controller 305 controls a power supply state of the power supply unit 313 in at least two states according to a power control signal or mode of the multimedia device 300. For example, when a power on command is received, the controller 305 operates such that electric energy supplied to the light source unit 308 from the power supply unit 313 may have a first level (a high level), and when a standby command is received, the controller 305 operates such that electric energy supplied to the light source unit 308 from the power supply unit 313 may have a second level (a middle or medium level).

Furthermore, the user interface 314 is designed to adjust at least one of the brightness and color of a target light source according to a power control signal or mode of the multimedia device 300.

For example, when a power control signal corresponds to a power on command signal, the user interface 314 sets desired brightness or color of the target light source to any one of at least three levels (e.g., high, middle, and low levels). The light source relates to the brightness or color of an indicator displayed through, for example, the logo type assembly 310.

In addition, when the power control signal corresponds to a standby command signal, the user interface 314 sets the brightness or color of the target light source to any one of at least three levels.

When the multimedia device 300 is in a specific mode (e.g., an e-mail receive mode, a software (SW) update mode, a boot process mode, etc.), the user interface 314 sets the brightness or color of the target light source to any one of at least three levels.

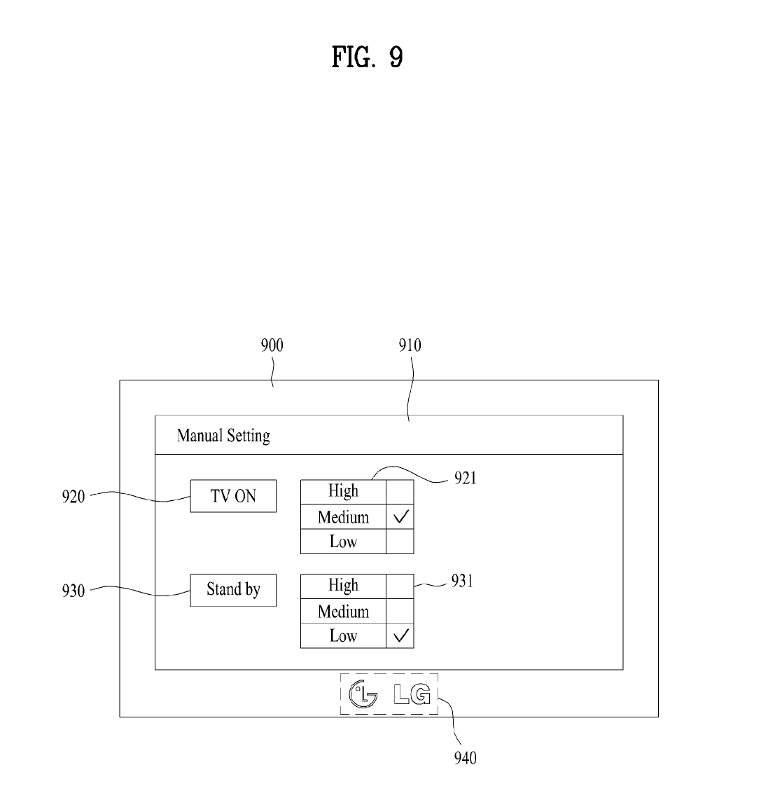

Thus, an embodiment of the present invention is technically advantageous in that a user may quickly and easily check the current power state, the current operation mode, or the like of the multimedia device 300. Hereinafter, a related graphical user interface (GUI) will be described in detail with reference to FIG. 9.

When the logo type assembly 310 is electrically connected to the touch sensor 309, the controller 305 changes the power state or operation mode of the multimedia device 300 according to information about a user touch location, number of times, duration, or the like, which is recognized by the touch sensor 309.

When the recognized information is within a first range (e.g., a case in which any one of two indicators is selected), the controller 305 switches the multimedia device 300 to a standby state. When the recognized information is within a second range (e.g., a case in which both of two indicators are selected), the controller 305 switches the multimedia device 300 to a power on state and execute a specific mode, which will be described with reference to FIGS. 13 to 16.

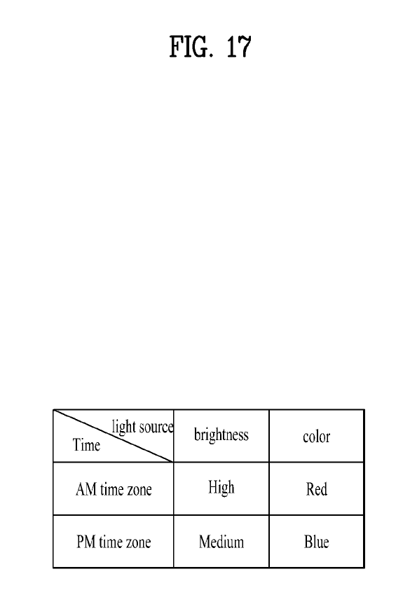

The time scheduler 307 is designed to count a current time in real time and the memory 306 stores brightness and color of a light source, which are to be controlled per time zone (e.g., morning/afternoon), which will be described with reference to FIG. 17. Thus, the controller 305 may control the brightness or color of the logo type indicator over time using the time scheduler 307 and the memory 306. By virtue of this design, the multimedia device 300 is advantageous for providing optimal brightness and color of a logo to a user per time zone.

FIG. 4 is a diagram of a structure of a logo type assembly according to an embodiment of the present invention. Hereinafter, a case in which the logo type assembly is mechanically implemented will be described with reference to FIG. 4. However, FIG. 4 is a diagram for explaining just an embodiment of the present invention and is not intended to limit the scope of the present invention.

The logo type assembly 310 shown in FIG. 3 includes a metal support frame 411 as a rectangular frame being opened in a central portion thereof, a printed circuit board (PCB) 414 on which a plurality of light emitting diodes (LEDs) 415 installed in the support frame 411 and irradiating light downwards from an upper portion are arranged, a light guide member 412 disposed in front of the PCB 414 in the support frame 411, and a reflecting plate 416 attached to a front surface of the PCB 414 and reflecting light irradiated from the LEDs 415, as shown in FIG. 4.

The light guide member 412 is formed of, for example, a synthetic resin material and includes a logo portion 413 formed on a front surface thereof. In addition, a rear surface of the light guide member 412 is inclined downwards from an upper portion thereof so as to face the LEDs 415.

The logo portion 413 is formed in such a way that a specific pattern, that is, a logo 413a may be integrally formed to be embossed or engraved with a front surface of the light guide member 412 and a region except for the logo 413a may be painted with a dark color such as black or the like so as to transmit light through a portion corresponding to the logo 413a only.

Alternatively, a tape, an acryl plate, or the like on which a transparent logo is formed may be formed in front of the light guide member 412 so as to transmit and emit light through a portion corresponding to the logo.

In addition, the PCB 414 is electrically connected to a controller of a multimedia device and stepwise controls the LEDs 415 according to a power state and different modes of a multimedia device.

In addition, the support frame 411 includes fixing pieces 41 la bent to extend outwards on opposite lateral surface portions thereof and upper and lower support pieces 411b and 411c bent to extend inwards on upper and lower portions thereof such that upper and lower edges of the PCB 414 may be fixedly supported by the upper and lower support pieces 411b and 411c, respectively.

The logo type assembly shown in FIG. 4 is connected to a touch sensor and a controller. Thus, a command signal for change of the multimedia device to a power on/off state or a standby state is generated according to a location, frequency, or duration that the logo type indicator (assembly) is touched.

For example, when the logo type indicator is touched once, a command signal for changing to the standby state is transmitted to the controller. Thus, the controller is designed to lower a power level of a power supply unit to a predetermined level according to the command signal for change to the standby state.

When the logo type indicator is touched twice, a command signal for change to the power off state is transmitted to the controller. Thus, the controller is designed to completely block power of the power supply unit according to the command signal for change to the power off state. In this case, the same power saving effect may be achieved as in a case when the multimedia is disconnected from an external power line.

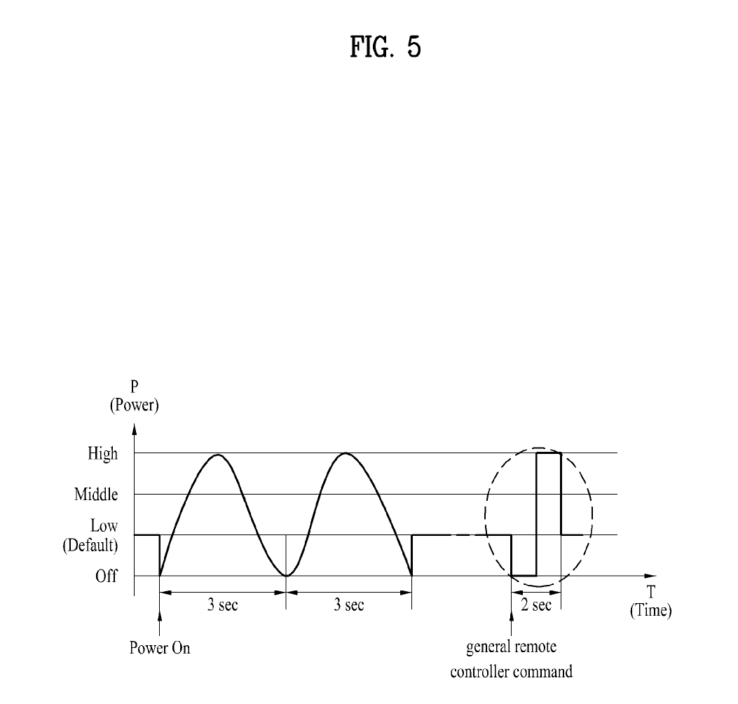

Experimental data about electric energy for adjusting the brightness of light emitted from a light source through the logo type assembly shown in FIGS. 3 and 4 will be described with reference to FIGS. 5 to 8.

FIG. 5 is a graph showing experimental data about a power supply state of a multimedia device that receives a power on signal, according to an embodiment of the present invention.

First, the multimedia device is designed to supply default power (default electric energy), that is, low level power to a light source when in a standby state. In addition, the multimedia device is designed to successively supply power such that a cycle of about 3 seconds is repeated twice and then a default value is supplied to the light source when receiving a power on command, as shown in FIG. 5. Thus, a user may recognize that the logo type indicator gradually becomes light and then dark, and then is held at a low brightness level. Of course, the multimedia device may be designed to control the two indicators 221 and 222 shown in FIG. 2 at the same time or only one of the two indicators 221 and 222 according to a need of one of ordinary skill in the art.

When a general remote controller command (e.g., a channel control command, a volume control command, etc.) signal except for a power related command signal is received, the brightness of the logo type indicator is primarily changed to an off state from a low level, is secondarily changed to a high level from the off state, and is tertiarily changed to a low level (default) from the high level, as shown in FIG. 5. However, the multimedia device is advantageous in that the user may receive different feedback with respect to the power related command and commands that are not related to power by adjusting power that is discretely supplied, unlike in the case of the aforementioned power related command.

In addition, the multimedia device has the technical effect whereby the user may individually set the level and default shown in the graph of FIG. 5 or may set the level and default stepwise, which is completely different from a conventional technology for simply turning on/off of a power lamp.

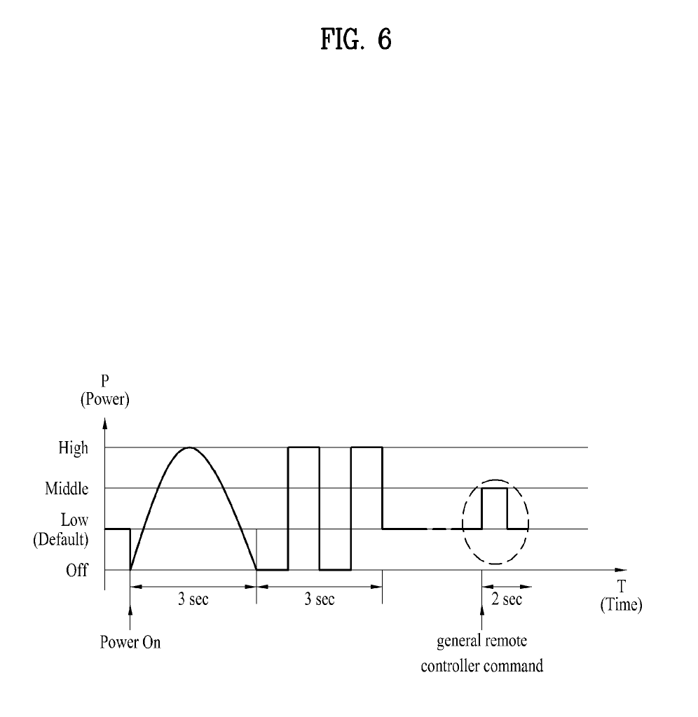

FIG. 6 is a graph showing experimental data about a power supply state of a multimedia device that receives a power on signal, according to another embodiment of the present invention.

First, the multimedia device is designed to supply default power (default electric energy), that is, low level power to a light source when in a standby state, which is the same as in FIG. 5.

However, unlike in FIG. 5, the multimedia device is designed to supply power such that a cycle of about 3 seconds is performed once and then discrete level change occurs twice upon receiving a power on command, as shown in FIG. 6. Thus, the user may recognize that the logo type indicator gradually becomes light and then dark once, and then blinks twice. Of course, the multimedia device may be designed to control the two indicators 221 and 222 shown in FIG. 2 at the same time or only one of the two indicators 221 and 222 according to a need of one of ordinary skill in the art.

When a general remote controller command (e.g., a channel control command, a volume control command, etc.) signal except for a power related command signal is received, the brightness of the logo type indicator is primarily changed to a middle level from a low level and is secondarily changed to a low level from the middle level again, as shown in FIG. 6. That is, unlike in FIG. 5, the multimedia device of FIG. 6 is advantageous in that processing speed is improved by simply designing a light source to simply change according to a received general remote controller command signal.

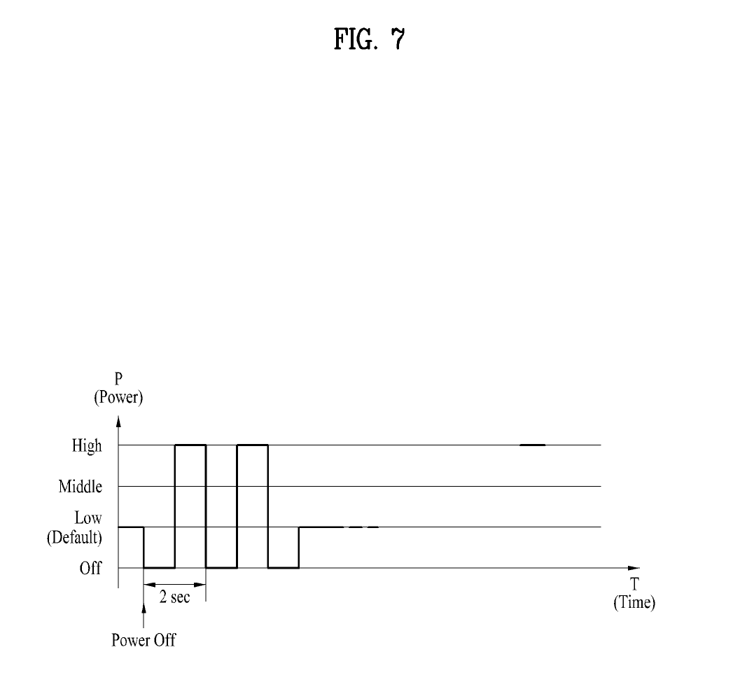

FIG. 7 is a graph showing experimental data about a power supply state of a multimedia device that receives a power off signal, according to another embodiment of the present invention. The case of FIG. 7 may also be applied to a case in which the multimedia device is switched from a standby state to a power off state or is switched from the power on state to the standby state.

For example, when power supplied to a light source of the logo type indicator is in a low level state (default), if a power off command signal is received, maximum power is discretely supplied twice, is switched to a low level state, and then is held, as shown in FIG. 7.

That is, in FIG. 5, when the power on command signal is received, maximum power is supplied such that a cycle is successively repeated twice. However, in FIG. 6, when the power off command signal is received, maximum power is discretely supplied twice. Thus, the multimedia device is advantageous in that the user may receive different feedback according to power states.

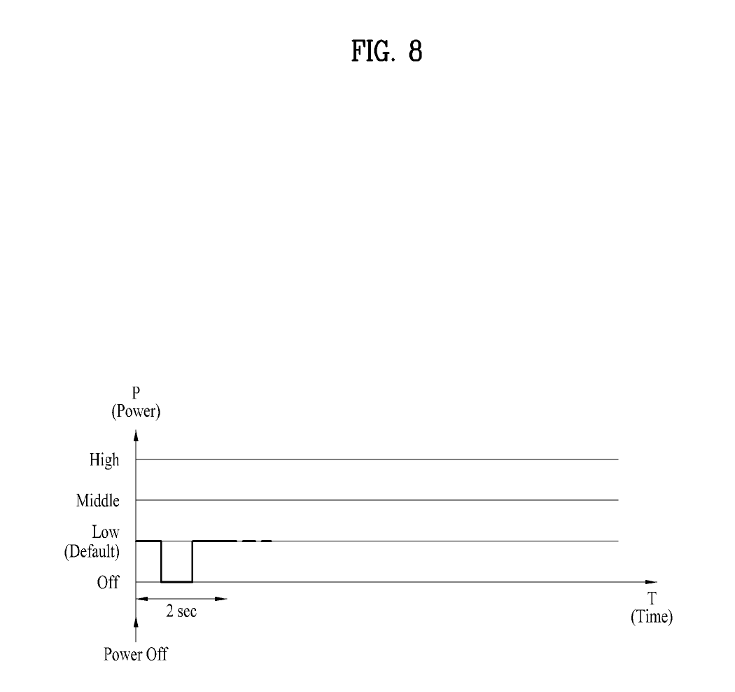

FIG. 8 is a graph showing experimental data about a power supply state of a multimedia device that receives a power off signal, according to another embodiment of the present invention. As in FIG. 7, the case of FIG. 8 may also be applied to a case in which the multimedia device is switched from a standby state to a power off state or is switched from the power on state to the standby state.

For example, when power supplied to a light source of the logo type indicator is in a low level state (default), if a power off command signal is received, minimum (that is, off) power is discretely supplied, is switched to a low level state, and then is held, as shown in FIG. 8.

In FIG. 6, when the power on command signal is received, electric energy of supplied power successively changes or when the general remote controller command signal is received, power discretely increases to a middle level. On the other hand, in FIG. 8, when the power off command signal is received, the logo type indicator instantly becomes dark and returns to a default state. Thus, the multimedia device is advantageous in that the user may receive different feedback with respect to respective states.

In FIGS. 5 to 8, the experimental graphs are separately described for convenience of description. However, another embodiment obtained by combining the experimental graphs is within the scope of the present invention according to a need of one of ordinary skill in the art.

FIG. 9 is a diagram of a GUI for setting a state of a logo type indicator 940, according to an embodiment of the present invention. Hereinafter, a process of arbitrarily setting brightness of the logo type indicator by a user will be described with reference to FIG. 9.

First, a user of a multimedia device 900 according to the present embodiment may select an option such as a menu or the like and may directly set the brightness of the logo type indicator. For example, when an option, manual setting 910, is selected, detailed option items are displayed, as shown in FIG. 9.

In this case, when the user selects a first option 920 for control of brightness of a TV in an on state, a level list 921 including at least three items which can be additionally selected by the user is displayed. That is, the user can select any one of brightness levels output on the level list 921.

When the user selects a second option 930 for control of brightness of the TV in a standby state, a level list 931 including at least three items which can be additionally selected by the user is displayed. In this case, the user may also select any one of brightness levels output on the level list 931.

According to a level selected in the level lists 921 and 931 shown in FIG. 9, the brightness of the logo type indicator 940 is controlled for each power state. A detailed solution for this may be implemented with reference to FIGS. 5 to 8.

Although FIG. 9 shows a case in which only brightness is controlled for each power state, an embodiment in which a GUI is changed so as to select color of the logo type indicator 940 is within the scope of the present invention. In addition, an additional GUI may be provided so as to select brightness or color of the logo type indicator 940 not only in a power state, but also in other general modes (e.g., a SW update mode, a boot process mode, an e-mail receive mode, etc.) of the multimedia device 900.

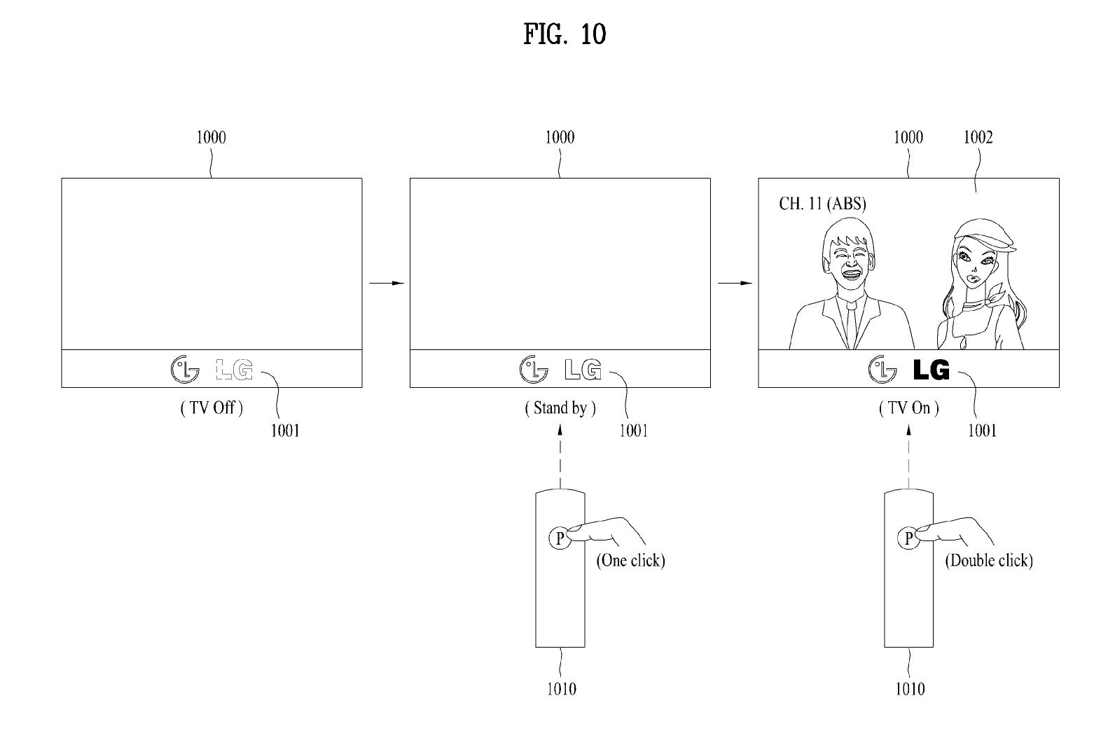

FIG. 10 is a diagram showing a first process in which a state of a logo type indicator 1001 is changed, according to an embodiment of the present invention. Hereinafter, the logo type indicator 1001 that is changed according to a degree by which a power button of a remote controller 1010 is selected will be described with reference to FIG. 10.

First, the multimedia device 1000 (e.g., a TV) displays the logo type indicator 1001 at low level brightness in a power off state, as shown in a left side of FIG. 10.

When the power button of the remote controller 1010 is selected once, the multimedia device 1000 is changed to a standby state and simultaneously displays the logo type indicator 1001 at middle level brightness, as shown in a central side of FIG. 10.

Lastly, when the power button of the remote controller 1010 is selected twice, the multimedia device 1000 outputs a previously displayed image 1002 on a screen, as shown in a right side of FIG. 10. In addition, the multimedia device 1000 displays the logo type indicator 1001 at maximum level brightness.

Thus, the user may easily check a current state of a multimedia device by simply checking a logo type indicator. Hardware efficiency may be improved in that a logo type indicator according to an embodiment of the present invention may replace both a conventional power lamp and a static logo image. In addition, brightness, color, and the like of a logo are frequently changed to attract users' interest, thereby increasing advertising effects. In FIG. 10, it is assumed that only brightness of the English word ‘LG’ of the logo type indicator is dynamically adjusted. However, an embodiment in which a design logo part other than a word is adjusted together or selectively is within the scope of the present invention according to a need of one of ordinary skill in the art.

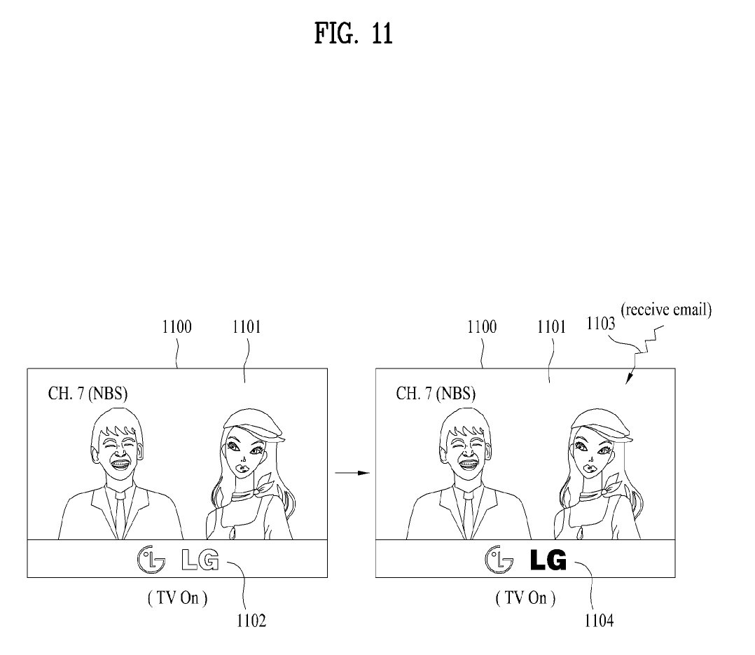

FIG. 11 is a diagram showing a second process in which a state of a logo type indicator 1102 is changed, according to an embodiment of the present invention. Hereinafter, a process in which brightness of the logo type indicator 1102 is automatically changed when a multimedia device 1100 enters a specific mode will be described with reference to FIG. 11.

In a power on state, the multimedia device 1100 according to the present embodiment outputs video data 1101 of a current channel selected by a user, as shown in a left side of FIG. 11. Of course, according to a function provided by the multimedia device 1100, a broadcast image, that is, the video data 1101 may be replaced by an application execution image or a webpage execution image. The logo type indicator 1102 may be displayed at initial default brightness (i.e., low brightness).

Furthermore, it is assumed that the multimedia device 1100 according to the present embodiment outputs the video data 1101 of a current channel, and simultaneously, a user logs in to a specific website which operates as a background image. The specific web page provides a personal e-mail service.

After logging in, when a new e-mail is received to a personal e-mail address of the specific website (1103), the multimedia device 1100 controls a logo type indicator 1104 at maximum brightness, as shown in a right side of FIG. 11. Thus, the user may quickly check the new e-mail that just arrived by calling the webpage operating as the background image. In addition, under this design, the multimedia device 1100 may have technical effects whereby a user may be notified that an e-mail is received without interference with respect to a previous broadcast image, that is, the video data 1101.

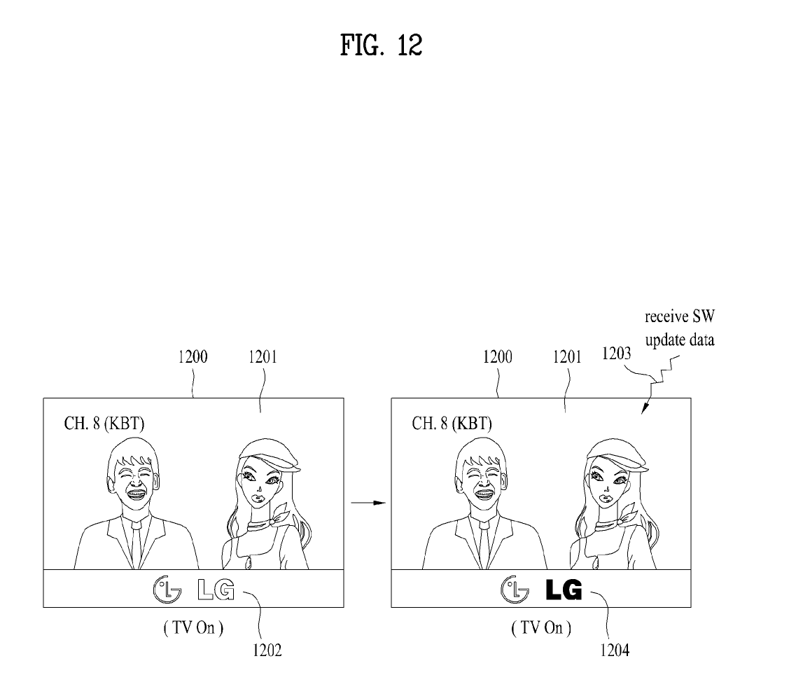

FIG. 12 is a diagram showing a third process in which a state of a logo type indicator 1202 is changed, according to an embodiment of the present invention. Hereinafter, a process in which brightness of the logo type indicator 1202 is automatically changed when a multimedia device 1200 enters a specific mode will be described with reference to FIG. 12.

In a power on state, the multimedia device 1200 according to the present embodiment outputs video data 1201 of a current channel selected by a user, as shown in a left side of FIG. 12. Of course, according to a function provided by the multimedia device 1200, a broadcast image, that is, the video data 1201 may be replaced by an application execution image or a webpage execution image. The logo type indicator 1202 may be displayed at initial default brightness (i.e., low brightness).

Furthermore, when a SW update data is completely received or a boot process proceeds, the multimedia device 1200 controls a logo type indicator 1204 at maximum brightness, as shown in a right side of FIG. 12. Thus, a user may quickly check whether SW update is completed without interference with respect to a previous broadcast image, that is, the video data 1201.

FIG. 13 is a diagram showing a fourth process in which a state of a logo type indicator 1301 is changed, according to an embodiment of the present invention. Hereinafter, an embodiment in which only one of indicators including a plurality of sub logos is selected will be described.

As described with reference to FIG. 2, the present invention may be applied to an indicator including a plurality of sub logos (e.g., an English word part and a design logo part).

First, a multimedia device 1300 according to the present embodiment displays a plurality of indicators 1301 at default brightness in a power off state, as shown in a left side of FIG. 13. In this case, as described with reference to FIG. 3, the multimedia device 1300 is designed in such a way that each logo type assembly is electrically connected to a touch sensor so as to recognize whether a user touches logo type assemblies.

It is assumed that the user selects (1302) only a design logo part 1303, but not an English word ‘LG’ among a plurality of sub logos, as shown in a left side of FIG. 13.

Thus, as shown in a right side of FIG. 13, the multimedia device 1300 is automatically changed from a power off state to a standby state. In addition, only brightness of the design logo part 1303 touched by the user is changed to a middle level or a highest level. A multimedia device designed in such a way that brightness of another logo part that is not touched by the user, that is, an English word part is changed to a middle level or a highest level is within the scope of the present invention.

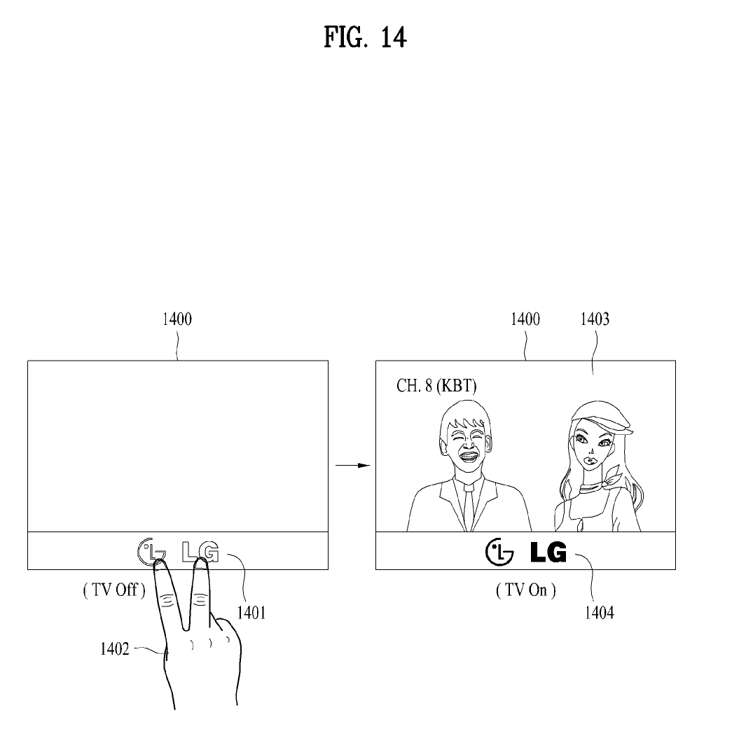

FIG. 14 is a diagram of a fifth process in which a state of a logo type indicator 1401 is changed, according to an embodiment of the present invention. Compared with FIG. 13, FIG. 14 shows a case in which all sub logos are touched.

First, as shown in a left side of FIG. 14, a multimedia device 1400 according to the present embodiment displays a plurality of indicators 1401 at default brightness in a power off state.

It is assumed that a user simultaneously selects a design logo part and an English word part 1404 among a plurality of sub logos, as shown in a left side of FIG. 14.

Thus, the multimedia device 1400 outputs an execution image 1403 while being automatically changed from a power off state to a power on state, as shown in a right side of FIG. 14. That is, the multimedia device 1400 has an effect for jumping directly to a power on state without a standby state, unlike in FIG. 13.

Brightness of the design logo part and English word part 1404 that are touched by the user is changed to a middle level or a highest level. That is, in FIG. 13, the user can be notified that a multimedia is in a standby state by adjusting brightness of only one of a plurality of sub logos. In addition, in FIG. 14, the user can be notified that the multimedia device is in a power on state by adjusting brightness of all sub logos.

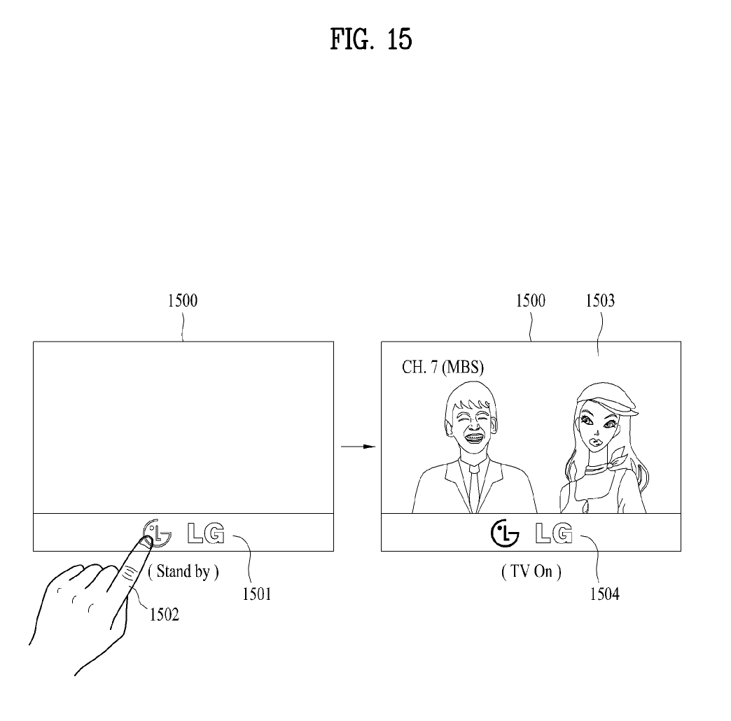

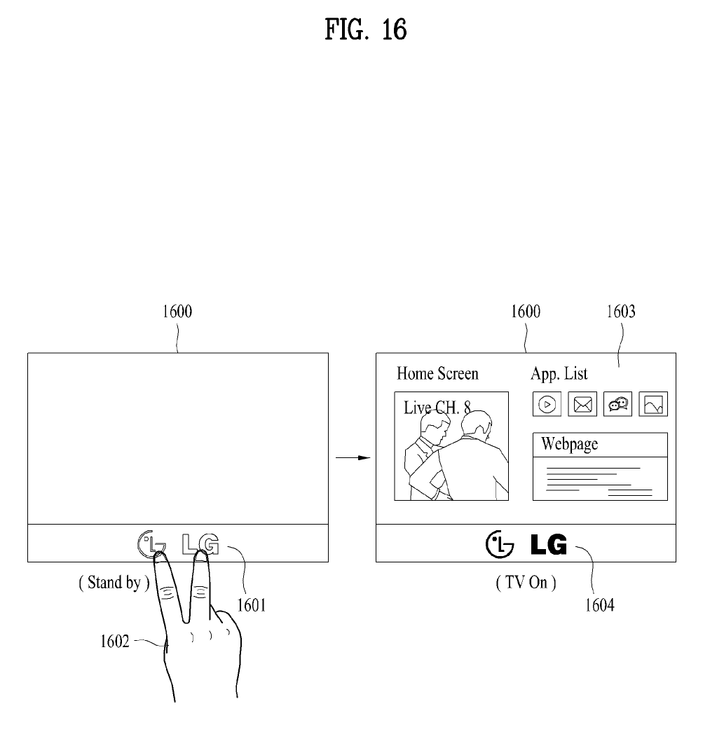

Thus far, the embodiments in which a power off state is changed to a standby state or a power on state have been described with reference to FIGS. 13 and 14. Hereinafter, a process of performing functions of a multimedia device in different modes when a standby state is changed to a power on state will be described in detail with reference to FIGS. 15 and 16.

FIG. 15 is a diagram of a sixth process in which a state of a logo type indicator 1501 is changed, according to an embodiment of the present invention.

First, a multimedia device 1500 according to the present embodiment displays a plurality of indicators 1501 at default brightness or middle level brightness in a standby state, as shown in a left side of FIG. 15.

It is assumed that a user selects (1502) only a design logo part 1504 among a plurality of sub logos, as shown in a left side of FIG. 15. In this case, the multimedia device 1500 outputs a broadcast image 1503 of a channel that is a previously tuned to while being automatically changed to a power on state, as shown in a right side of FIG. 15. In addition, only the design logo part 1504 is changed to highest level brightness.

FIG. 16 is a diagram of a seventh process in which a state of a logo type indicator 1601 is changed, according to an embodiment of the present invention.

First, a multimedia device 1600 according to the present embodiment displays a plurality of indicators 1601 at default or middle level brightness in a standby state, as shown in a left side of FIG. 16.

It is assumed that a user selects (1602) both a design logo part and an English word part 1604 among the plurality of sub logos, as shown in a left side of FIG. 16. In this case, as shown in a right side of FIG. 16, the multimedia device 1600 outputs a home screen image 1603 while being automatically changed to a power on state. The home screen image 1603 includes, for example, a live broadcast channel image displayed on a first region, a downloaded application list displayed on a second region, and a webpage execution image displayed on a third region.

Both the design logo part and English word part 1604 that are touched by the user are displayed at highest level brightness.

That is, to sum up with reference to FIGS. 15 and 16, the case in which a multimedia device outputs different execution images (e.g., a simple channel image, a home screen image, etc.) according to the number of touches of a plurality of logo type indicators in a standby state is within the scope of the present invention.

FIG. 17 is a diagram showing a database (DB) for adjusting brightness/color of a logo type indicator based on a current time, according to an embodiment of the present invention. Hereinafter, the DB for automatically setting brightness/color of a logo type indicator per time zone regardless of user setting will be described with reference to FIG. 17.

The logo type indicator according to the present embodiment may provide a GUI to allow a user to have high visibility and to set various levels, as shown in FIG. 9. The brightness or color of the logo type indicator may be controlled per time zone regardless of user setting, thereby minimizing influence of surroundings.

For example, different brightness levels and color types of a logo type indicator are set according to a morning time zone (AM time zone) or an afternoon time zone (PM time zone), as shown in FIG. 17. Under this design, dazzling due to sun light in the morning time zone may be prevented, and a clear indicator may be provided in consideration of fluorescent light in the afternoon time zone. Only the morning/afternoon time zones are separately described with reference to FIG. 17. However, according to a need of one of ordinary skill in the art, a time zone may be grouped to as many time zones as possible or the brightness and color of an indicator are subdivided and set in consideration of weather information received through a network interface, which is within the scope of the present invention.

Furthermore, the brightness or color of a logo type indicator may be adjusted according to surrounding brightness of a multimedia device, regardless of the time zones shown in FIG. 17. To this end, the feature of adding an illuminance sensor or the like to a multimedia device is within the scope of the present invention.

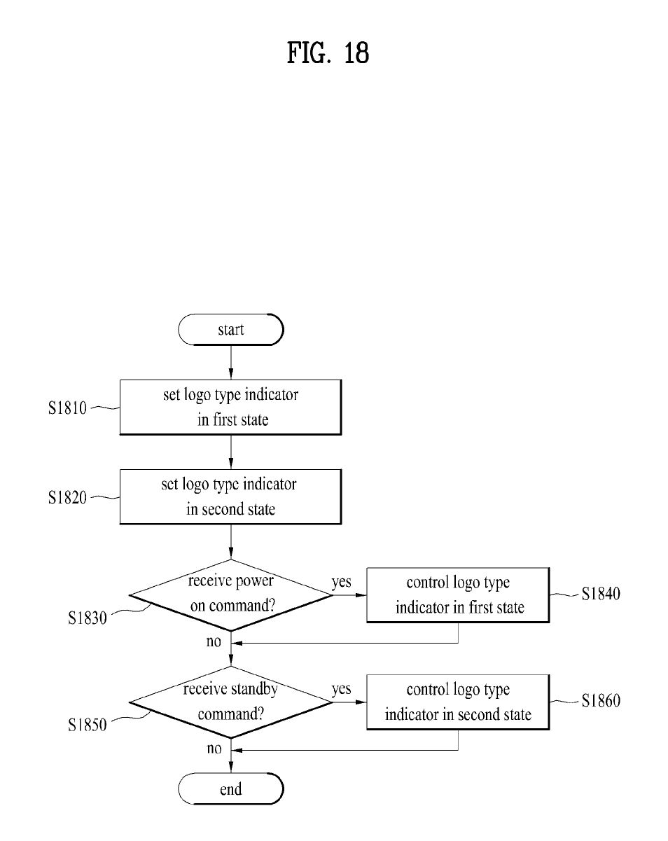

FIG. 18 is a flowchart of a method of controlling a multimedia device according to an embodiment of the present invention. The feature of the method shown in FIG. 18, which will be described with reference to FIGS. 1 to 17 together, is within the scope of the present invention.

The method of controlling the multimedia device according to the present embodiment includes setting a first state of a logo type indicator to be displayed, in a power on state of the multimedia device (S1810) and setting a second state of the logo type indicator to be displayed, in a standby state of the multimedia device (S1820), which has been thoroughly described with reference to FIG. 9, and thus, the description is not repeated herein.

Whether a power on command signal for control of the multimedia device is received is determined (S1830). As a determination result, when the power on command signal is received, the logo type indicator is controlled in the first state (S1840).

Whether a standby command signal for control of the multimedia device is received is determined (S1850). As a determination result, when the standby command signal is received, the logo type indicator is controlled in the second state (S1860).

According to another embodiment of the present invention, steps S1840 and S1860 further include primary controlling the logo type indicator at preset maximum brightness and secondarily controlling the logo type indicator in the first state or the second state after a preset time elapses. The first state and the second state each correspond to at least one of brightness and color for displaying the logo type indicator.

Although not shown in FIG. 18, according to another embodiment of the present invention, the method of FIG. 18 further includes receiving a general remote controller command signal (for example, the general remote controller command signal does not include a power on command or a standby command) for control of the multimedia device and controlling the logo type indicator in a third state. For example, in the controlling of the logo type indicator in the third state, the logo type indicator is controlled such that power is supplied in a discrete form to a light source related to the logo type indicator, which has been thoroughly described with reference to FIGS. 5 and 6, and thus, the description is not repeated herein.

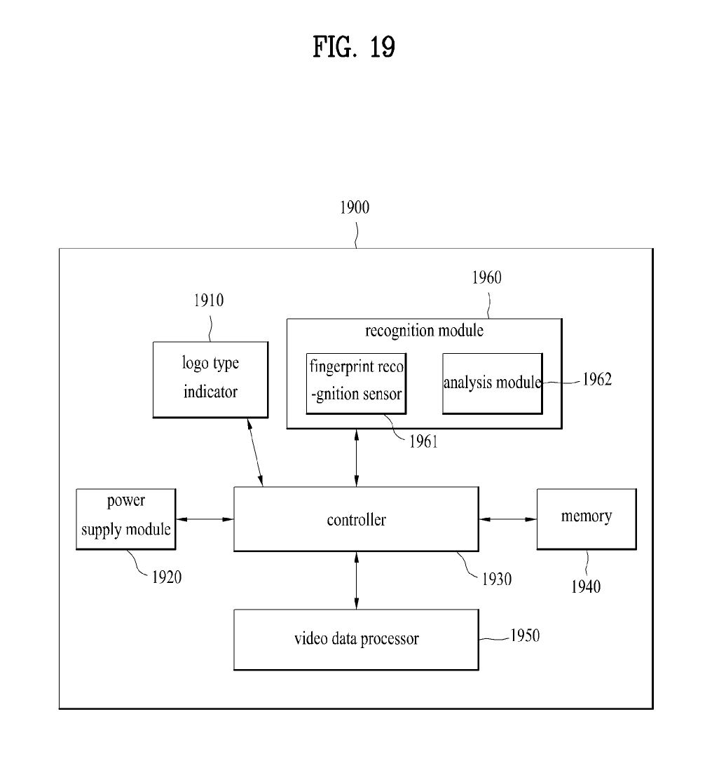

Another embodiment obtained based on FIGS. 1 to 18 is within the scope of the present invention. Embodiments shown in FIGS. 19 to 28 can be induced by one of ordinary skill in the art with reference to the embodiments shown in FIGS. 1 to 18.

FIG. 19 is a detailed block diagram of internal modules of a multimedia device 1900 according to another embodiment of the present invention. Hereinafter, the solution for performing different functions for each user who touches a logo type indicator will be described with reference to FIG. 19.

As shown in FIG. 19, the multimedia device 1900 for adjusting a logo type indicator according to the preset embodiment includes a logo type indicator 1910, a power supply module 1920, a controller 1930, a memory 1940, a video data processor 1950, and a recognition module 1960. Furthermore, according to another embodiment of the present invention, the recognition module 1960 includes a fingerprint recognition sensor 1961 and an analysis module 1962. The modules of FIG. 19 are shown for convenience of description. In addition, some modules can be omitted or added according to a need of one of ordinary skill in the art. Accordingly, the scope of the present invention is defined by the appended claims.

The logo type indicator 1910 is independently positioned from a screen of the multimedia device 1900, and for example, is positioned on a bezel portion of a TV.

When the logo type indicator 1910 is touched by a user, the recognition module 1960 identifies the corresponding user.

The power supply module 1920 switches the multimedia device 1900 from a first power state to a second power state. The first power state corresponds to, for example, a standby state, and the second power state corresponds to, for example, a power on state.

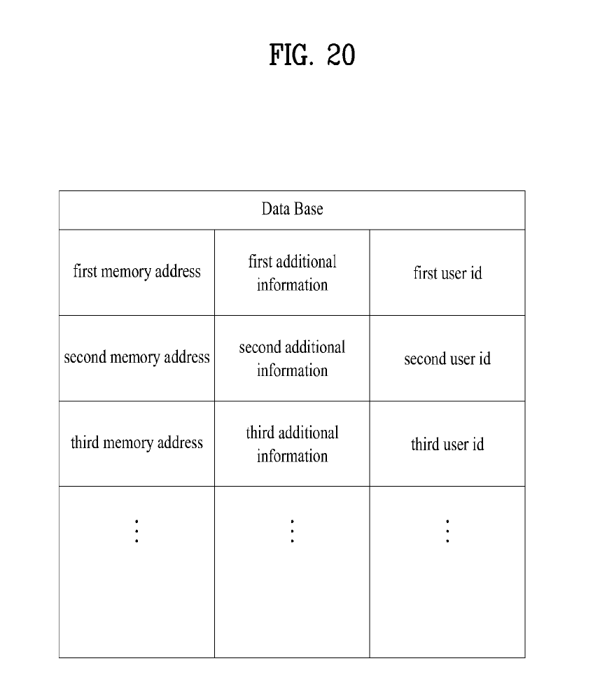

The memory 1940 stores at least one set of user identification information and corresponding additional information, which will be described in detail with reference to FIG. 20.

The controller 1930 accesses the memory 1940 to extract additional information corresponding to the identified user. In addition, the video data processor 1950 is controlled to preferentially process video data displayed on a screen of the multimedia device 1900 according to the extracted additional information.

Furthermore, the recognition module 1960 includes the fingerprint recognition sensor 1961 that is electrically connected to the logo type indicator 1910 and the analysis module 1962 for analysis of a fingerprint obtained from the user's touch.

The controller 1930 is designed to access the memory 1940 and extract user ID information corresponding to the analyzed fingerprint.

The memory 1940 maps first additional information set by the user and corresponding ID information to each other, stores the first additional information and the corresponding ID information in a first memory address, maps second additional information that is not related to user setting and corresponding user ID information to each other, and stores the second additional information and the corresponding user ID in a second memory address.

The controller 1930 automatically or manually selects and extracts the first additional information or the second additional information. The first additional information corresponds to, for example, a preferred channel, and the second additional information corresponds to, for example, a mode that is executed when power is off in a log in state.

Thus, according to a user who touches the plurality of logo type indicators 221 and 222 of FIG. 2, different initial images are displayed on a TV. In FIG. 19, it is assumed that a user is identified via a fingerprint recognition sensor. An embodiment in which a user is identified via iris scan or face recognition is within the scope of the present invention.

FIG. 20 is a diagram of a DB stored in a memory of a multimedia device, according to another embodiment of the present invention. Hereinafter, a technology for displaying different initial images of the multimedia device according to a user who touches a logo type indicator will be described with reference to FIG. 20.

The multimedia device according to the present embodiment stores the DB shown in FIG. 20 in the memory. First additional information and first user ID which are mapped to each other are stored in a first memory address. Second additional information and second user ID which are mapped to each other are stored in a second memory address. Third additional information and third user ID which are mapped to each other are stored in a third memory address.

For example, when a first user is identified by a fingerprint recognition sensor that is electrically connected to a logo type indicator, a power state of the multimedia device is changed from a standby state to a power on state to output an imaging corresponding to the first additional information. The first additional information corresponds to, for example, a specific preferred channel that is preset by the first user.

As another example, when a second user is identified by the fingerprint recognition sensor that is electrically connected to the logo type indicator, the power state of the multimedia device is changed from the standby state to the power on state to output an imaging corresponding to the second additional information. The second additional information corresponds to, for example, a broadcast mode that is executed just before the second user logs out or the multimedia device is powered off.

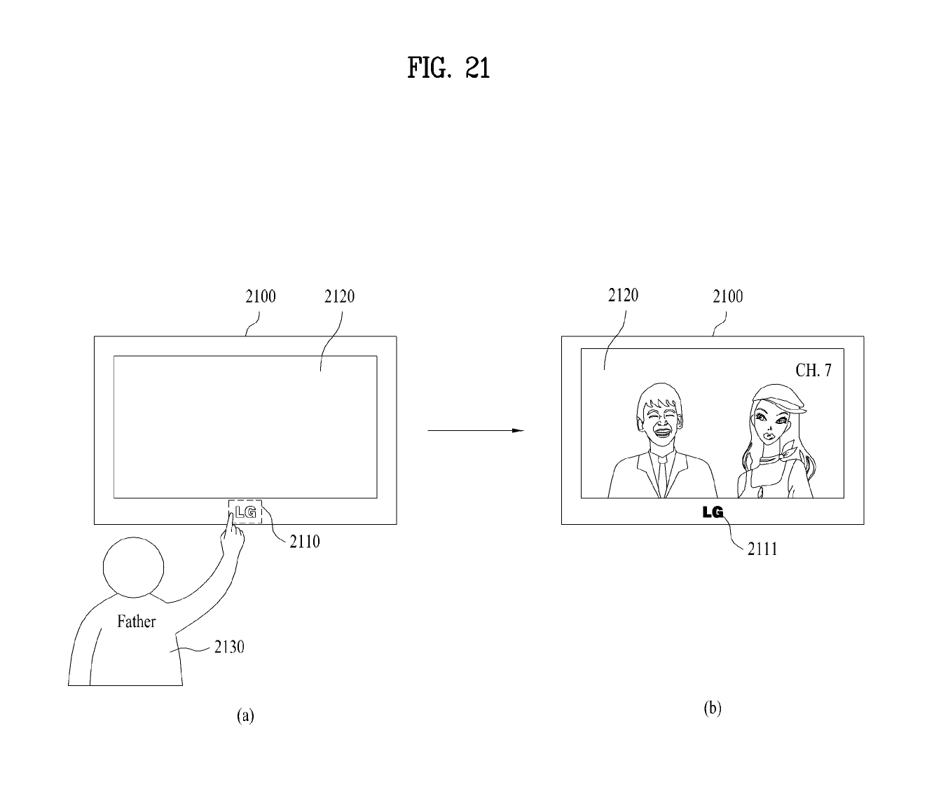

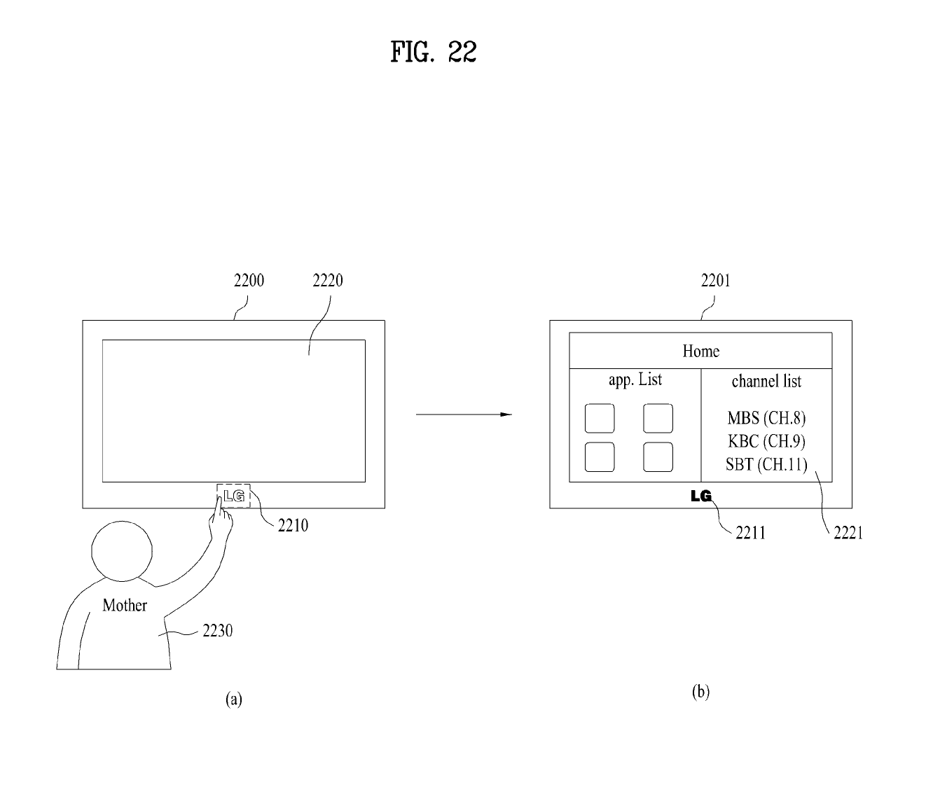

The first user and the first additional information will be described in more detail with reference to FIG. 21. In addition, the second user and the second additional information will be described in more detail with reference to FIG. 22.

FIG. 21 is a diagram showing a process in which a multimedia device 2100 is changed to a power on state according to a touch of a first user 2130, according to another embodiment of the present invention.

As shown in (a) of FIG. 21, the multimedia device 2100 is currently in a standby state to output a black image 2120. In this case, it is assumed that the first user 2130 touches a logo type indicator 2110. As described above, the logo type indicator 2110 is electrically connected to a fingerprint recognition sensor.

Thus, as shown in (b) of FIG. 21, the multimedia device 2100 which recognizes the first user 2130 outputs, as an initial image, video data of a specific preferred channel 2121 corresponding to the first user 2130. Furthermore, the multimedia device 2100 is designed in such a way that a logo type indicator 2111 may also indicate a power on state.

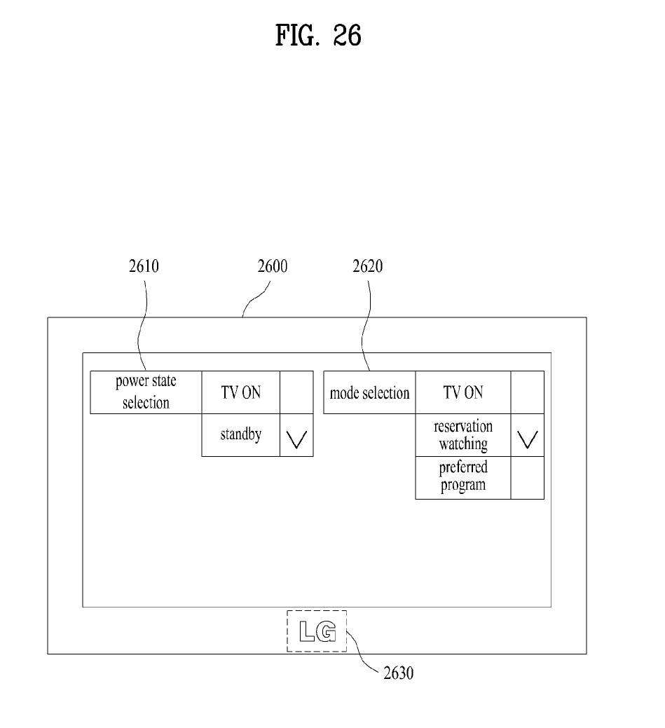

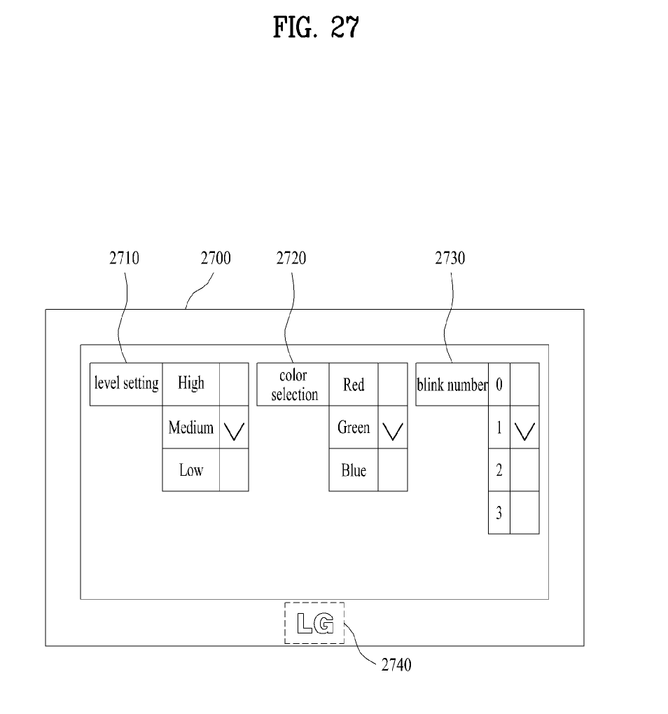

In addition, the logo type indicator 2111 may be optimized according to user preference, which will be described in more detail with reference to FIGS. 26 and 27.

FIG. 22 is a diagram showing a process in which a multimedia device 2200 is changed to a power on state according to a touch of a second user 2230, according to another embodiment of the present invention.

As shown in (c) of FIG. 22, the multimedia device 2200 is currently in a standby state to output a black image 2220. In this case, it is assumed that the second user 2230 touches a logo type indicator 2210. As described above, the logo type indicator 2210 is electrically connected to a fingerprint recognition sensor.

Thus, as shown in (b) of FIG. 22, a multimedia device 2201 which recognizes the second user 2230 outputs, as an initial image, video data of a specific mode 2221 which the second user 2230 has accessed just before the second user logs out or the multimedia device is powered off (for example, a home menu image before the second user logs out or the multimedia device is powered off is used). In addition, the multimedia device 2200 is designed such that a logo type indicator 2211 may display a power on state.

In addition, the logo type indicator 2211 may be optimized using a method preferred by a user, which will be described in more detail with reference to FIGS. 26 and 27.

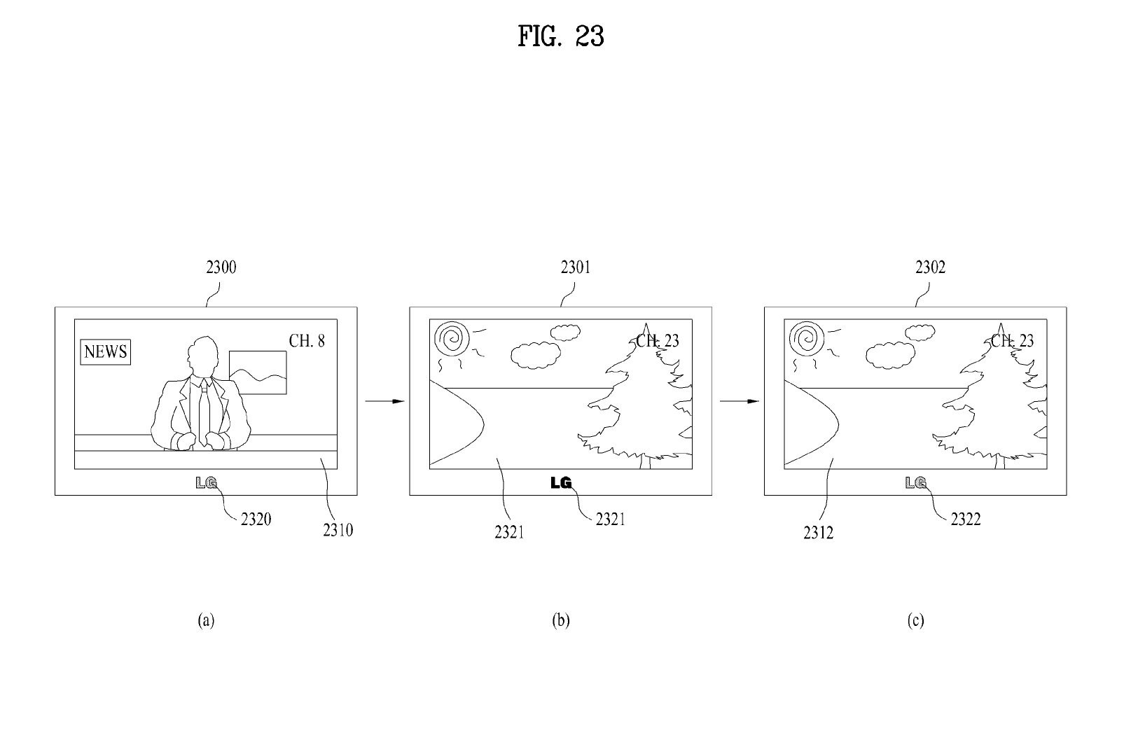

FIG. 23 is a diagram showing a process in which a multimedia device 2300 changes a state of a logo type indicator when a specific event occurs, according to an embodiment of the present invention. Hereinafter, a process for changing a state of the logo type indicator regardless of a power state when the specific event occurs will be described with reference to FIG. 23.

As shown in (a) of FIG. 23, when the multimedia device 2300 is in a power on state, a logo type indicator 2320 is displayed at middle level brightness. In addition, the multimedia device 2300 outputs a corresponding broadcast image through an arbitrary channel 2310. In this case, it is assumed that a specific broadcast program that is reserved by a user is started through another channel (e.g., channel No. 23).

Thus, as shown in (b) of FIG. 23, a multimedia device 2301 outputs a broadcast image 2311 corresponding to a reserved specific broadcast program and adjusts brightness of a logo type indicator 2321. The multimedia device 2301 is advantageous in that a user who checks the logo type indicator 2321, brightness of which is adjusted, can quickly check a channel that is reserved by the user. That is, a current channel is switched to a channel that is reserved using two methods. As a first solution, brightness, color, and the like of the logo type indicator 2321 while the current channel is automatically switched to the reserved channel. As a second solution, before the current channel is converted into the reserved channel, the brightness, color, and the like of the logo type indicator 2321 are previously adjusted, thereby giving the user a choice. According to the second solution, the user may have an effect for selecting any one of a reserved channel and a channel that is currently watched by the user at a time when the user reserves a broadcast program.

In addition, a multimedia device designed like in FIG. 23 may address problems in terms of displaying additional information on a conventional broadcast screen and may use a logo type indicator positioned on a bezel outside the screen.

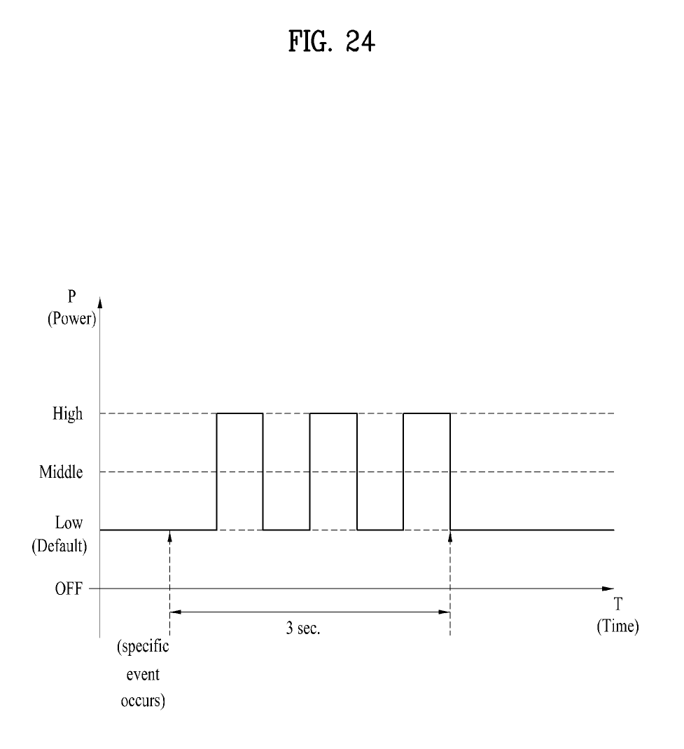

In addition, as shown in (c) of FIG. 23, a multimedia device 2302 changes a state of a logo type indicator 2322 again while outputting a broadcast image 2312 of a reserved channel. That is, when the logo type indicator 2320 shown in (a) of FIG. 23, the logo type indicator 2321 shown in (b) of FIG. 23, and the logo type indicator 2322 shown in (c) of FIG. 23 are compared, the logo type indicators 2320, 2321, and 2322 blink temporally, and thus, are advantageous for quickly showing a state of a multimedia device. A detailed internal process for implementing this will be described with reference to FIG. 24.

FIG. 24 is a diagram related to an internal process for supplementary description of FIG. 23. Hereinafter, a method of holding a blink state of a logo type indicator for a preset period when a specific event occurs will be described with reference to FIG. 24. In FIG. 24, it is assumed that brightness of a logo type indicator is changed according to power supply. However, an embodiment in which color of the logo type indicator is changed is within the scope of the present invention.

It is assumed that when a multimedia device is in a power on state, lowest power is supplied to a logo type indicator. When a specific event occurs, power supplied to the logo type indicator is discretely changed for about 3 seconds three times, as shown in FIG. 24. Thus, a user may check that the logo type indicator blinks for 3 seconds three times. In addition, given this design, a user can quickly and easily recognize that the specific event occurs.

The specific event may correspond to, for example, a mode for recording arbitrary content, a reserve watching/recording mode, a case in which specific content preferred by a user is automatically detected, or the like.

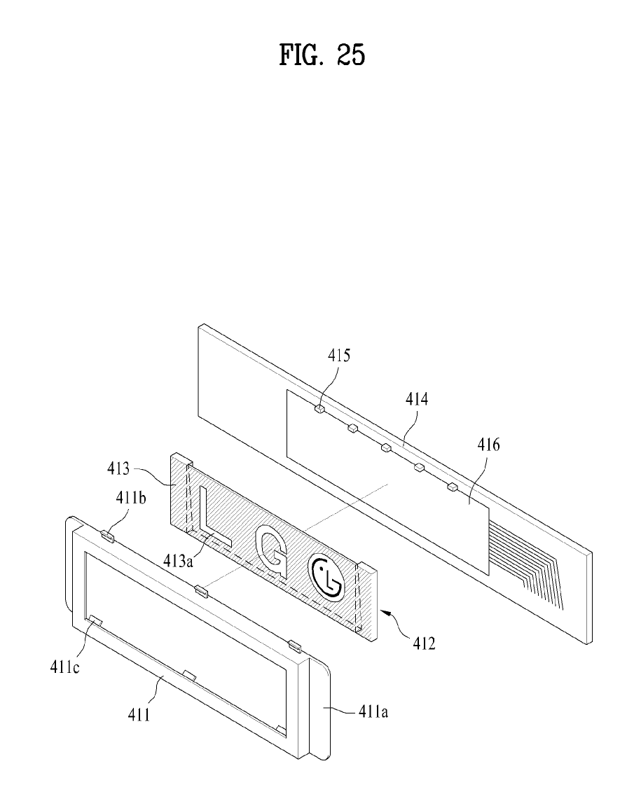

FIG. 25 is a diagram of a structure of a logo type assembly according to another embodiment of the present invention. Some elements have been described with reference to FIG. 4, and thus, description thereof will be omitted herein.

As shown in FIG. 25, the logo type assembly according to the present embodiment includes a light guide member 412.

The light guide member 412 is formed of, for example, an opaque synthetic resin and includes the logo portion 413 formed on a front surface thereof. In addition, In addition, a rear surface of the light guide member 412 is inclined downwards from an upper portion thereof so as to face the LEDs 415.

Furthermore, according to the present embodiment, the light guide member 412 is electrically connected to at least one of a fingerprint recognition sensor and a touch recognition sensor. Thus, when an arbitrary user touch a logo part, a multimedia device may analyze a fingerprint of the user and may access a pre-registered fingerprint DB, thereby quickly identifying the arbitrary user.

FIG. 26 is a diagram of an example of a GUI provided by a multimedia device 2600 according to another embodiment of the present invention. Hereinafter, an example of the GUI provided by the multimedia device 2600 will be described with reference to FIG. 26.

The multimedia device 260 according to the present embodiment may provide options for setting a state of a logo type indicator 2630 for each respective specific event, as shown in FIG. 26.

A first option 2610 is used to specify a power state of a TV and a second option 2620 is used to specify a mode state of the TV. According to the first option 2610 and the second option 2620, the color, brightness, and blink level of the logo type indicator 2630 are changed. A detailed method will be described with reference to FIG. 27.

FIG. 27 is a diagram of an example of a GUI provided by a multimedia device 2700 according to another embodiment of the present invention. Hereinafter, an example of the GUI provided by the multimedia device 2700 will be described with reference to FIG. 27.

The multimedia device 2700 according to the present embodiment may provide options for setting states of the logo type indicator 2630 to detailed levels, as shown in FIG. 27. That is, the multimedia device 2700 of FIG. 27 may be implemented based on the multimedia device 2600 of FIG. 26, or alternatively, an embodiment in which the multimedia device 2700 of FIG. 27 and the multimedia device 2600 of FIG. 26 are independently designed is within in the scope of the present invention.

A first option 2710 is used to set a brightness level of a logo type indicator 2740 according to a TV power state or mode state set in FIG. 26.

A second option 2720 is used to set color of the logo type indicator 2740 according to the TV power state or mode state set in FIG. 26.

In addition, a third option 2730 is used to set the number of times that the logo type indicator 2740 blinks according to the TV power state or mode state set in FIG. 26.

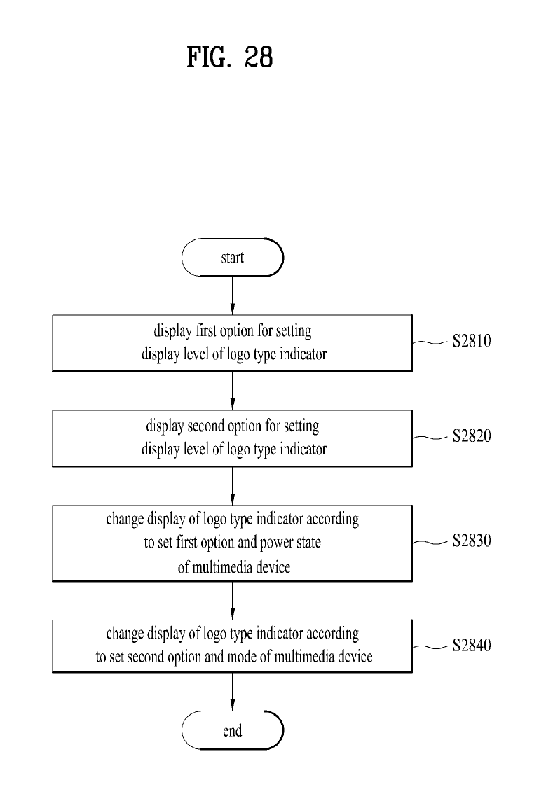

FIG. 28 is a flowchart of a method of controlling a multimedia device according to another embodiment of the present invention. The method of controlling the multimedia device according to the present embodiment will be described with reference to FIG. 28.

The multimedia device according to the present embodiment may be implemented via steps shown in FIG. 28. Of course, an embodiment in which some steps are omitted, changed, or added according to a need of one of ordinary skill in the art is within the scope of the present invention.

The multimedia device displays a first option for setting a display level of a logo type indicator according to a power state of the multimedia device (S2810). The logo type indicator may be independently positioned from a screen of the multimedia device.

The multimedia device displays a second option for setting a display level of the logo type indicator according to a mode of the multimedia device (S2820). The first option and the second option may be displayed at the same time or different times.

The multimedia device is designed to change display of the logo type indicator according to the set first option and power state of the multimedia device (S2830).

In addition, the multimedia device is designed to change the display of the logo type indicator according to the set second option and mode of the multimedia device (S2840).

Although not shown in FIG. 28, the multimedia device may be designed in such a way that the method further includes adjusting a state of a light source through the logo type indicator according to the display level.

A state of the light source includes at least one of, states corresponding to color and blink interval.

Throughout this specification, FIGS. 1 to 28 have been separately described for convenience of description. However, it is obvious that an embodiment obtained by combining some features of FIGS. 1 to 28 is within the scope of the present invention.

In addition, throughout this specification, both device and method inventions have been described. As necessary, the description of the device and method inventions may be applied supplementarily.

Embodiments of the present invention can include a computer readable medium including program commands for executing operations implemented through various computers.

The computer readable medium can store program commands, data files, data structures or combinations thereof. The program commands recorded in the medium may be specially designed and configured for the present invention or be known to those skilled in the field of computer software. Examples of a computer readable recording medium include magnetic media such as hard disks, floppy disks and magnetic tapes, optical media such as CD-ROMs and DVDs, magneto-optical media such as floptical disks, or hardware devices such as ROMs, RAMs and flash memories, which are specially configured to store and execute program commands. Examples of the program commands include a machine language code created by a compiler and a high-level language code executable by a computer using an interpreter and the like. The hardware device may be configured as at least one software module in order to perform an operation of the present invention, and vice versa.

According to an embodiment of the present invention, an indicator may provide various functions by combining a conventional logo lamp and a printed logo.

Another embodiment of the present invention provides an interface for directly setting an execution mode of a logo type indicator by a user or a solution for automatically changing the execution mode of the logo type indicator according to a state of the multimedia device.

Furthermore, another embodiment of the present invention provides a technology for executing different functions of a multimedia device based on information of a location, a time, and the like that a logo type indicator is touched.

In addition, another embodiment of the present invention provides a technology for automatically changing brightness, color, and the like of a logo type indicator based on information of a current time, surrounding brightness, and the like.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A multimedia device for controlling a logo type indicator according to a power control signal, the multimedia device comprising:
a power supply unit for supplying power;
a light source unit for emitting light in a specific direction according to power supplied by the power supply unit;
a logo type assembly designed to transmit light emitted from the light source unit, the logo type assembly being positioned at one side surface of a screen with video data output from the multimedia device being displayed thereon; and
a controller for controlling a power supply state of the power supply unit in at least two states according to a power control signal or mode of the multimedia device.

2. The multimedia device according to claim 1, further comprising a user interface for setting at least one of brightness and color of a target light source according to the power control signal or mode of the multimedia device.

3. The multimedia device according to claim 2, wherein:
the user interface sets brightness or color of the target light source to any one of at least three levels when a power control signal corresponds to a power on command signal; and
the user interface sets the brightness or color of the target light source to any one of at least three levels when the power control signal corresponds to a standby command signal.

4. The multimedia device according to claim 2, wherein the user interface sets the brightness or color of the target light source to any one of at least three levels when the multimedia device is in a specific mode.

5. The multimedia device according to claim 1, wherein the controller changes a power state or an operation mode of the multimedia device according to information about a user touch location, number, or frequency, which is recognized by a touch sensor, when the logo type indicator is electrically connected to the touch sensor.

6. The multimedia device according to claim 5, wherein the controller switches the multimedia device to a standby state when the user touch location or number which is recognized by the touch sensor is within a preset first range.

7. The multimedia device according to claim 5, wherein the controller switches the multimedia device to a power on state and executes a specific mode when the user touch location or number which is recognized by the touch sensor is within a preset second range.

8. The multimedia device according to claim 1, further comprising a time scheduler for counting a current time in real time,
wherein the controller controls brightness or color of a target light source according to the counted current time.

9. A method of controlling a logo type indicator according to a power control signal, the method comprising:
setting a first state of a target logo type indicator in a power on state of the multimedia device;
setting a second state of the target logo type indicator in a standby state of the multimedia device;
controlling the logo type indicator in the first state when a power on signal for control of the multimedia device is received; and
controlling the logo type indicator in the second state when a standby command for control of the multimedia device is received.

10. The method according to claim 9, wherein the controlling of the logo type indicator in the first state and the controlling of the logo type indicator in the second state comprise:
primarily controlling the logo type indicator at preset maximum brightness; and
secondarily controlling the logo type indicator in the first state and the second state after a preset period of time elapses, respectively.

11. The method according to claim 9, wherein the first state and the second state each correspond to at least one of brightness and color for displaying the logo type indicator.

12. The method according to claim 9, further comprising:
receiving a general remote controller command signal for control of the multimedia device, the general remove controller command signal not including a power on or standby command; and
controlling the logo type indicator in a third state.

13. The method according to claim 12, wherein the controlling the logo type indicator in the third state comprises controlling the controlling the logo type indicator such that power is supplied in a discrete form to a light source related to the logo type indicator.

14. The method according to claim 9, wherein the multimedia device corresponds to any one of a digital television (DTV), a network TV, an Internal protocol television (IPTV), a smart TV, and a web TV.

15. A computer readable recording medium having recorded thereon a program for executing the method of claim 9.

16. The method according to claim 9, further comprising:
generating a command signal for switching the multimedia device to a power on state, a power off state, or a standby state according to a location, frequency, or duration that the logo type indicator is touched; and
changing electric energy of a power supply unit to a preset level according to the generated command signal.

17. A multimedia device for controlling a logo type indicator positioned independently from a screen of the multimedia device, the multimedia device comprising:
a recognition module for identifying a corresponding user when the logo type indicator is touched;
a power supply module for switching the multimedia device from a first power state to a second power state;
a memory for storing at least one user identification information and corresponding additional information;
a controller accessing the memory to extract the additional information corresponding to the identified user; and
a video data processor controlled to preferentially output video data on the screen of the multimedia device according to the extracted additional information.

18. The multimedia device according to claim 17, wherein the recognition module comprises:
a fingerprint recognition sensor electrically connected to the logo type indicator; and
a analysis module for analyzing a fingerprint obtained from a user's touch,
wherein the controller is designed to access the memory to extract user identification (ID) information corresponding to the analyzed fingerprint.

19. The multimedia device according to claim 17, wherein:
the memory maps first additional information set by a user and corresponding ID information to each other and stores the first additional information and the corresponding ID information in a first memory address, and
the memory maps second additional information that is not related to user setting and corresponding user ID information to each other, and stores the second additional information and the corresponding user ID information in a second memory address.

20. The multimedia device according to claim 19, wherein the controller selectively extracts the first additional information or the second additional information.

21. The multimedia device according to claim 20, wherein the first additional information corresponds to a preferred channel, and the second additional information corresponds to a mode that is executed when power is off in a log in state.

22. The multimedia device according to claim 17, wherein the first power state corresponds to a standby state, and the second power state corresponds to a power on state.

23. A method of controlling multimedia device for controlling a logo type indicator, the method comprising:
displaying a first option for setting a display level of a logo type indicator according to a power state of the multimedia device, the logo type indicator being positioned independently from a screen of the multimedia device;
displaying a second option for setting a display level of the logo type indicator according to a mode of the multimedia device, the first option and the second option being displayed at the same time or different times;
changing display of the logo type indicator according to the set first option and power state of the multimedia device; and
changing the display of the logo type indicator according to the set second option and mode of the multimedia device.

24. The multimedia device according to claim 23, further comprising adjusting a state of a light source through the logo type indicator according to the display level.

25. The multimedia device according to claim 24, wherein the state of the light source comprises at least one of brightness, color, and blink interval.
